(19) United States
(12) Patent Application Publication
(10) Pub. No.: US 2003/0019576 A1
(43) Pub. Date: Jan. 30, 2003

(54) Electronic component removal method through application of infrared radiation

(75) Inventors: Afranio Torres-Filho, Enfield, CT (US); Lawrence N. Crane, Brookfield, CT (US)

Correspondence Address: LOCTITE CORPORATION, Legal Department, 1001 Trout Brook Crossing, Rocky Hill, CT, 06067, US

(73) Assignee: LOCTITE CORPORATION

(21) Appl. No.: 10/120,542

(22) Filed: Apr. 12, 2002

Related U.S. Application Data
(60) Provisional application No. 60/301,755, filed on Jun. 27, 2001.

(51) Int. Cl. B32B 35/00

(52) U.S. Cl. 156/344

(57) ABSTRACT

A method of removing an electronic component from a substrate to which it is electrically interconnected through softening of a cured resin composition is disclosed. The method involves applying infrared radiation directly to the electronic component such that radiant energy transfers through the electronic component to the resin composition, to cause the resin composition to soften. The radiant energy may be transferred directly through the electronic component, such as when the electronic component is at least partially transparent to infrared radiation. Also, the radiant energy may be transferred indirectly, with the electronic component at least partially absorbing the infrared radiation, causing an increase in temperature of the electronic component, which in turn causes an increase in temperature of the resin composition. After the resin composition is softened, it is removed from the substrate.

### BACKGROUND OF THE INVENTION

1. Field of the Invention

This invention relates to removal of an electronic component connected to a substrate through a resin composition. More particularly, the present invention relates to a method of removing an electronic component such as a semiconductor from a circuit board substrate through softening of an underfill resin composition using radiant energy.

2. Brief Description of Related Technology

Semiconductor devices, such as chip size or chip scale packages, typically include a semiconductor chip, such as large scale integration, on a carrier substrate. Such semiconductor devices are typically mounted onto circuit board substrates and are incorporated into a variety of electronic devices. In recent years, the popularity of small-sized electronic appliances, such as camera-integrated video tape recorders and portable telephone sets, has made size reduction of large scale integration devices desirable. As a result, chip scale packages are being used to reduce the size of packages substantially to that of bare chips. Such assemblies improve the characteristics of the electronic device while retaining many of their operating features, thus serving to protect semiconductor bare chips and facilitate testing thereof.

Ordinarily, the chip assembly is connected to electrical conductors on a circuit board by use of a solder connection or the like. However, when the resulting structure is exposed to thermal cycling, the reliability of the solder connection between the circuit board and the chip assembly often becomes suspect. In recent practice, after a chip assembly is mounted on a circuit board, the space between the chip assembly and the circuit board is often filled with a sealing resin (often referred to as underfill sealing) in order to relieve stresses caused by thermal cycling, thereby improving heat shock properties and enhancing the reliability of the structure.

However, since thermosetting resins are typically used as the underfill sealing material, in the event of a failure after the chip assembly is mounted on the circuit board, it is very difficult to replace the chip assembly without destroying or scrapping the structure in its entirety.

To that end, techniques for mounting a bare chip on a circuit board are accepted as substantially similar to the mounting of a chip assembly onto a circuit board. Japanese Laid-Open Patent Publication No. 69280/94 discloses a process where a bare chip is fixed and connected to a substrate by use of a resin capable of hardening at a predetermined temperature. In the event of failure, this bare chip is removed from the substrate by softening the resin at a temperature higher than the predetermined temperature. However, no specific resin is disclosed, and there is no disclosure about treating the resin which remains on the substrate.

Japanese Laid-Open Patent Publication No. 251516/93 also discloses a mounting process using bisphenol A type epoxy resin (CV5183 or CV5183S; manufactured by Matsushita Electric Industrial Co., Ltd.). However, the removal process so disclosed does not consistently permit easy removal of the chip, the curing step is lengthy at elevated temperatures, and the process generally results in poor productivity.

Of course, mechanical methods of removing/replacing semiconductor chips from/on a substrate are known, such as by cutting the chip to be removed/replaced. An example of such teaching is disclosed in U.S. Pat. No. 5,355,580 (Tsukada).

Thermoplastic underfill resins are known for use in semiconductor chip attachment, as described in U.S. Pat. No. 5,783,867 (Belke, Jr.). However, such thermoplastic resins tend to leak under relatively modest temperature conditions. In contrast, thermosetting resins cure into a matrix which ordinarily have greater thermal stability under end use operating temperatures.

U.S. Pat. Nos. 5,512,613 (Afzali-Ardakani), U.S. Pat. No. 5,560,934 (Afzali-Ardakani) and U.S. Pat. No. 5,932,682 (Buchwalter), each refer to a reworkable thermoset composition based on a diepoxide component in which the organic linking moiety connecting the two epoxy groups of the diepoxide includes an acid cleavable acyclic acetal group. With such acid cleavable acyclic acetal groups forming the basis of the reworkable composition, a cured thermoset need only be introduced to an acidic environment in order to achieve breaking of the chemical bonds of the acetal group and a loss of much of its adhesiveness.

U.S. Pat. No. 5,872,158 (Kuczynski) refers to thermosetting compositions capable of curing upon exposure to actinic radiation, which are based on acetal diacrylates, and reaction products of which are reported to be soluble in dilute acid.

U.S. Pat. No. 5,760,337 (Iyer) refers to thermally reworkable crosslinked resins to fill the gap created between a semiconductor device and a substrate to which it is attached. These resins are produced by reacting a dienophile (with a functionality greater than 1) with a 2.5-dialkyl substituted furan-containing polymer.

International Patent Publication No. PCT/US98/00858 refers to a thermosetting resin composition capable of sealing underfilling between a semiconductor device including a semiconductor chip mounted on a carrier substrate and a circuit board to which said semiconductor device is electrically connected. Here, the area around the cured thermoset is to be heated at a temperature of about 190° C. to about 260° C. for a period of time ranging from about 10 seconds to about 1 minute in order to achieve softening and a loss of much of its adhesiveness.

U.S. Pat. Nos. 5,948,922 (Ober) and U.S. Pat. No. 5,973,033 (Ober), each refer to a certain class of compounds having tertiary oxycarbonyl linkages, and compositions based on such compounds, which when cured provide decomposable compositions capable of being reworked.

As pointed out in Japanese Laid-Open Patent Publication No. 77264/94, it is conventional to use a solvent to remove residual resin from a circuit board. However, swelling the resin with a solvent is a time consuming process and the corrosive organic acid ordinarily used as the solvent may reduce the reliability of the circuit board. Instead, that disclosure speaks to a method for removing residual resin by irradiation with electromagnetic radiation

As noted, various compositions are capable of being reworked, such as by thermal degradation to provide for removal of a chip assembly from a circuit board substrate. U.S. Pat. No. 5,423,931 discloses removing an electronic component attached to a circuit board by a resin, and removing any residual resin through ultraviolet radiation. The removal of the electronic component is accomplished through the use of a heating block, which imparts difficult processing steps in the removal process. This patent also discloses heating the resin with infrared radiation through the board from the back of the board if the board is transparent to infrared radiation. Such application of infrared radiation through the back of a board, however, requires a circuit board which is transparent to infrared radiation, and can adversely affect other areas of the board due to exposure of the infrared radiation to a large portion of the board as well as heating of the board from the infrared radiation.

Japanese Laid-Open Patent Publication No. 102343/93, involves a mounting process where a bare chip is fixed and connected to a circuit board by use of a photocurable adhesive, where, in the event of failure, this bare chip is removed therefrom. However, this technique is limited to those instances where the circuit board includes a transparent substrate (e.g., glass) which permits exposure to light from the back side, and the resulting structure exhibits poor heat shock properties.

U.S. Pat. No. 5,269,868 discloses a method for separating a liquid crystal display device by applying ultraviolet radiation through a glass substrate to deteriorate the adhesive between the glass substrates and separate the substrates. Such a method relates to the use of liquid crystal displays including glass substrates, and requires ultraviolet radiation.

Notwithstanding the state of the art, it would be desirable for a method of removing a chip from an assembly without the use of chemical solvents and without the need for complex heating devices that may compromise the integrity of the semiconductor devices remaining on the substrate or the substrate itself.

### SUMMARY OF THE INVENTION

The present invention provides a method of removing an electronic component from a substrate to which the electronic component is electrically interconnected, with the electronic component and the substrate being contacted by a cured resin composition, and desirably being adhered to each other through the resin composition. The cured resin composition is capable of softening upon exposure to infrared radiation and/or elevated temperature conditions. The method of the invention involves applying infrared radiation directly to the electronic component, such that radiant energy transfers through the electronic component to the resin composition. This may be accomplished through conditions in which the radiant energy is transferred directly through the electronic component and/or indirectly through the electronic component. For example, the electronic component may be at least partially transparent to the infrared radiation, causing the infrared radiation to at least partially transmit directly through the electronic component to the resin composition, thereby causing the resin composition to soften. The electronic component may at least partially absorb the infrared radiation, causing an increase in temperature of the electronic component, which causes an increase in temperature of the resin composition due to the electronic component being contacted by the resin composition, thereby causing the resin composition to soften. Desirably, radiant energy is directly and indirectly transferred to the resin composition through both of these conditions. After the resin composition is softened in this manner, the electronic component is removed from the substrate.

Desirably, the infrared radiation at least partially transmitted directly through the electronic component is absorbed by the resin composition and causes the resin composition to increase in temperature, thereby causing the resin composition to soften.

The resin composition may be a photolytically cleavable resin which includes a photolytically cleavable linkage within the polymeric structure thereof which is capable of degradation upon exposure to infrared radiation. Alternatively, the resin composition may be a controllably degradable composition which is capable of decomposing under exposure to temperature conditions in excess of those used to cure the composition, such as a thermally cleavable resin which includes a thermally cleavable linkage within the polymeric structure thereof which is capable of degradation upon exposure to temperature conditions in excess of those used to cure the composition. The thermally cleavable resin may be the reaction product of a compound having at least one thermally cleavable linkage, a curing agent component for promoting cure of the compound, and optionally, an inorganic filler component.

In a further embodiment, the method may include a step of removing any residue of the resin composition which may remain on the substrate after the electronic component has been removed from the substrate. This may be accomplished by mechanical means, such as a rotating brush.

The infrared radiation may be applied using a well collimated beam of light or a focused beam of light. The focused beam of light may be applied using an apparatus including a source for producing light; a light guide for delivering the light produced by the source to the electronic component; a sensor for detecting the intensity of the light produced by the source; and a controller for determining the amount of light energy to be delivered to the adhesive composition.

In an alternate embodiment of the present invention, a method of softening a cured underfill sealant disposed between an electronic component and a substrate is provided. The method includes the step of applying infrared radiation having a wavelength of from about 700 to about 12,000 nm directly to the electronic component, wherein the infrared radiation causes an increase in temperature of the electronic component, thereby causing an increase in temperature of the underfill material, and wherein the infrared radiation at least partially transmits through the electronic component to the underfill material, thereby causing an increase in temperature of the underfill material. The increase in temperature of the underfill material causes the underfill material to soften.

In yet a further embodiment, a method of softening a cured underfill sealant disposed between an electronic component and a substrate includes the step of applying infrared radiation having a wavelength between about 700 and 12,000 nm directly to the electronic component, with the infrared radiation passing directly through the electronic component and being adsorbed by the underfill material, and with the underfill material softening upon exposure to the infrared radiation.

### DETAILED DESCRIPTION OF THE INVENTION

The present invention is directed to a method of removing an electronic component from a substrate to which it is electrically interconnected through a cured resin composition. The method involves applying infrared radiation directly to the electronic component such that radiant energy transfers through the electronic component and is absorbed by the resin composition, to cause the resin composition to soften. After the resin composition is softened, it is removed from the substrate.

The electronic component may be any electronic component for attachment to a circuit board substrate to form a circuit, as is known in the art. For example, the electronic component may be an integrated circuit chip such as a semiconductor chip. The electronic component may be constructed of any material known in the art, such as silicon, germanium, or the like. The electronic component may also be coated with a material which is capable of passivating environmental corrosion, such as a polyimide-, polybenzocyclobutane- or silicone nitride-based material. In particularly desirable embodiments, the electronic component is constructed of a material which is transparent to infrared radiation, such as silicon. The use of such material will be described in more detail herein with respect to the method of removal.

The electronic component is electrically interconnected to a substrate such as an integrated circuit board. The substrate may be constructed of any material known in the art, such as ceramic substrates Al₂O₃, SiN₃, and mullite (Al₂O₃—SiO₂); substrates or tapes heat resistant resins, such as polyimides; substrates of glass-reinforced epoxy; substrates of acrylonitrile-butadiene-styrene (ABS); phenolic substrates, and the like.

The electronic component is electrically interconnected to the substrate through electrical contacts, in known manner. Moreover, an adhesive composition may be provided for adhering the electrical component to the substrate, as is also known. Additionally, a cured resin composition in the form of an underfill material or underfill sealant is present between and in contact with the electronic component and the substrate. The underfill material relieves stress caused by thermal cycling, improves heat and mechanical shock properties and enhances the reliability of the structure. The underfill material may also participate in adhering the electrical component to the substrate, either in addition to or instead of a separate adhesive composition. As such, the electronic component and the substrate are adhered to each other through the underfill material.

The underfill material is a cured resin composition, which includes a reworkable component which is capable of softening upon exposure to infrared radiation and/or elevated temperature conditions. The presence of the reworkable component in the cured resin composition allows for repair, replacement, recovery and/or recycling of operative electronic components from assemblies that have become at least partly inoperative. As such, the reworkable component provides the assembled circuit with a point of detachment, such that the electronic component can be removed from the substrate in the event of failure of the electronic component.

Desirably, the cured resin composition is the cured reaction product of a thermosetting resin composition, such as a thermosetting resin composition including a reworkable component. By providing the underfill material as a thermosetting resin composition, it is capable of thermally curing by exposure to elevated temperature.

Moreover, the resin composition is capable of softening under exposure to appropriate conditions, which results in loss of adhesion to the substrate. Such softening may be achieved with the resin composition being controllably degradable, such that the composition is capable of degrading or decomposing under appropriate conditions. This may be achieved through a physical or a chemical degradation of the resin composition. For example, the resin composition may be a composition which undergoes considerable degradation in the physical properties thereof, such as through a reduction in the Young's Modulus of the composition, so as to physically soften the composition, resulting in loss of adhesion to the substrate. Also, the resin composition may undergo a chemical degradation which results in a loss of the physico-chemical properties thereof, such as when the resin composition, and in particular the reworkable component of the resin composition, includes a cleavable linkage within the polymeric structure thereof, which linkage cleaves or degrades under exposure to appropriate conditions, resulting in softening of the composition.

For example, at least a portion of the resin composition may be a photolytically cleavable resin which includes a photolytically cleavable linkage within the polymeric structure thereof. In this manner, the resin composition is capable of softening upon exposure to infrared radiation, for example due to the degradation of the linkage upon exposure to infrared radiation.

A portion of the resin composition may also, or alternatively, be a thermally cleavable resin which includes a thermally cleavable linkage within the polymeric structure thereof, and which is capable of softening upon exposure to temperature conditions in excess of those used to cure the composition, for example due to the degradation of the linkage upon exposure to such elevated temperature conditions.

More particularly, the resin composition may be a photothermally cleavable resin which includes a photothermally cleavable linkage within the polymeric structure thereof. As such, the resin composition is capable of softening upon exposure to temperature conditions in excess of those used to cure the composition, with the increased temperature conditions being brought about through a photo-induced mechanism, such as infrared radiation.

In desirable embodiments, the resin composition is capable of softening under exposure to infrared radiation by way of both a photolytic mechanism as well as a photothermal mechanism, as will be discussed in more detail herein.

As noted, the cured resin composition is the cured reaction product of a curable resin composition which includes a reworkable component. Prior to curing to form the cured reaction product, the curable resin composition includes any composition which is capable of thermally curing, providing adhesive and sealing properties, and which is capable of softening and/or degrading upon exposure to appropriate conditions of radiation and/or temperature.

The curable resin composition desirably includes a curable resin component, at least a portion of which is a reworkable component which includes at least one cleavable linkage, a curing agent component for promoting cure of the curable component, and optionally an inorganic filler component. Desirably, the curable resin component includes an epoxy or episulfide resin. As such, the curable resin composition may incorporate solely epoxy or episulfide resins which provide the reworkable aspect of cured reaction products thereof, or it may incorporate such epoxy or episulfide resins which together with a thermosetting epoxy composition, make up the curable resin composition. Desirably, the curable resin composition includes a reworkable epoxy or episulfide resin, a thermosetting epoxy composition, and a curing agent. For example, the reworkable epoxy or episulfide resin may represent from 10% to 100% of the curable resin composition, more desirably from 40% to 60% of the curable resin composition.

By way of example, the compound having at least one cleavable linkage may be selected from the group consisting of di- or multifunctional epoxides including acyclic acetal groups and full and partial episulfide equivalents thereof; di- or multifunctional epoxides including secondary carbonyl linkages and full and partial episulfide equivalents thereof; di- or multifunctional epoxides including tertiary carbonyl linkages and full and partial episulfide equivalents thereof; di- or multifunctional epoxides including an aromatic moiety within the structure and full and partial episulfide equivalents thereof, and mixtures and combinations thereof.

For example, epoxy compounds with at least one thermally cleavable linkage useful as the reworkable component may be chosen from those within the following formula:

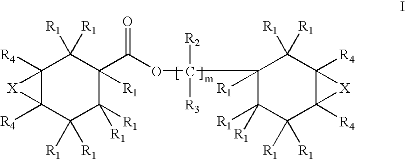

where each R₁ is independently selected from hydrogen, methyl, ethyl, propyl, isopropyl, butyl, isobutyl, tert-butyl, C₁₋₄ alkoxy, halogen, cyano and nitro; each R₄ is independently selected from hydrogen, methyl, ethyl, propyl and isopropyl; R₂ and R₃ are each independently selected from hydrogen, methyl, ethyl, propyl, phenyl, tolyl and benzyl, provided that both R₂ and R₃ cannot be hydrogen, X is independently selected from O and S, and m is 0 or 1. In desirable applications, at least one of R₂ and R₃ is phenol, tolyl, or benzyl.

The reworkable component may also be selected from epoxy compounds including two oxycarbonyl groups, the first and second oxycarbonyl groups being separated by an aromatic moiety. Such compounds may be chosen from aromatic ester linkages and aliphatic ester linkages with the aromatic moiety being present within the network structure. Particularly desirable are tert-ester linkages incorporating an aromatic moiety.

Desirable compounds having two oxycarbonyl groups separated by an aromatic moiety include those having the following structure:

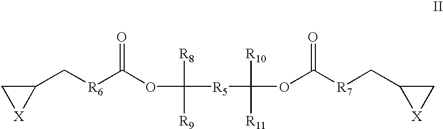

where R₅ is phenylene; R₆ and R₇ are each independently selected from methylene, ethylene, propylene, or phenylene; R₈ and R₉ are each independently selected from hydrogen, methyl, ethyl, and propyl, provided that both R₈ and R₉ cannot be hydrogen; R₁₀ and R₁₁ are each independently selected from hydrogen, methyl, ethyl, and propyl; and X is independently selected from O and S.

In particularly desirable compounds, R₅ is an ortho-substituted phenyl group, a meta-substituted phenyl group, or a para-substituted phenyl group.

Additional desirable compounds include those having the following formula:

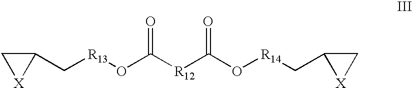

where R₁₂ is phenylene, R₁₃ and R₁₄ are independently selected from secondary or tertiary aliphatic moieties, and X is independently selected from O and S.

Compositions including a cleavable compound and including a partial or complete episulfide within the compound are also useful as reworkable compositions. For example, the curable composition may be:

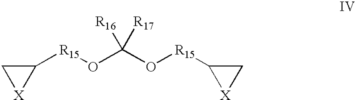

where each R₁₅ is independently selected from C₁-C₁₀ alkyl, cycloalkyl, aryl, aralkyl, and alkaryl; R₁₆ and R₁₇ are each independently selected from hydrogen, methyl, ethyl, propyl, phenyl, hydroxyphenyl, methoxyphenyl, tolyl, and benzyl; and X is independently selected from O and S. For example, the curable compound may be:

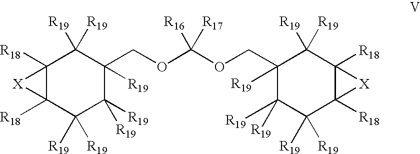

where R₁₆ and R₁₇ are each independently selected from hydrogen, methyl, ethyl, propyl, phenyl, hydroxyphenyl, methoxyphenyl, tolyl, and benzyl; each R₁₈ is independently selected from hydrogen, methyl, ethyl, propyl, and isopropyl; each R₁₉ is independently selected from hydrogen, methyl, ethyl, propyl, isopropyl, butyl, isobutyl, t-butyl, C₁₋₄ alkoxy, halogen, cyano and nitro; and X is independently selected from O and S.

The reworkable component may also be represented by the formula:

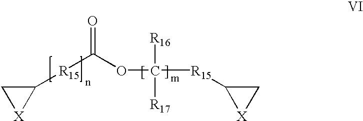

where each R₁₅ is independently selected from C₁-C₁₀ alkyl, cycloalkyl, aryl, aralkyl, and alkaryl; R₁₆ and R₁₇ are each independently selected from hydrogen, methyl, ethyl, propyl, phenyl, hydroxyphenyl, methoxyphenyl, tolyl, and benzyl; m is 0 or 1; n is 0 or 1, and X is independently selected from O and S. Combinations of such compounds may also be used.

Other useful reworkable compositions include those having a cyclic hydrocarbon moiety including an epoxy (or oxirane) or an episulfide (or thiirane) group, as well as an aromatic ether moiety also including an oxirane or thiirane group. The cyclic hydrocarbon moiety and the aromatic ether moiety are joined to each other through a carboxyl-containing linkage or a thiocarboxyl-containing linkage.

Each moiety of the compound may independently include either an epoxy group or an episulfide group. For example, the cyclic hydrocarbon moiety of the present invention desirably includes an oxirane group, such as a cycloaliphatic epoxy moiety. Alternatively, the cyclic hydrocarbon moiety may include a thiirane group, such as a cycloaliphatic episulfide moiety. Also, the aromatic ether moiety desirably includes an oxirane group, such as an aromatic glycidyl ether moiety. Alternatively, the aromatic ether moiety may include a thiirane group, such as an aromatic thioglycidyl ether moiety.

Such useful compounds may be defined by the following formula:

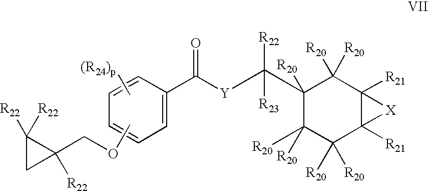

where R₂₀ is selected from hydrogen, methyl, ethyl, propyl, isopropyl, butyl, isobutyl, tert-butyl, C₁₋₄ alkoxy, halogen, cyano, nitro and phenyl; each R₂₁ is independently selected from hydrogen, methyl, ethyl, propyl, and isopropyl; R₂₂ and R₂₃ are independently selected from hydrogen, methyl, ethyl, propyl, phenyl, tolyl, and benzyl; R₂₄ is independently selected from hydrogen, methyl, ethyl, propyl, isopropyl, butyl, isobutyl, tert-butyl, C₁₋₄ alkoxy, halogen, cyano, nitro and phenyl; p is an integer from 0-4; and X and Y are independently selected from O and S.

As indicated, Y can be O or S, thus providing the structure with a carboxyl or thiocarboxyl linkage between the cyclic hydrocarbon moiety and the aromatic ether moiety. Desirably, Y is oxygen, producing a carboxyl linkage between the moieties.

Further, at least one of R₂₂ and R₂₃ may be other than hydrogen, producing a secondary linkage between the cycloaliphatic moiety and the aromatic ether moiety. More desirably, neither R₂₂ nor R₂₃ are hydrogen, producing a tertiary linkage between the cycloaliphatic moiety and the aromatic moiety.

The reworkable composition may further be a curable resin component chosen from those having at least two heteroatom-containing carbocyclic structures pending from a core structure, with the core structure containing at least one linkage selected from ether, thioether, carbonate and combinations thereof, which linkage is capable of being reworked under appropriate conditions so as to lose its adhesiveness. For example, the curable resin may be represented by the following structure:

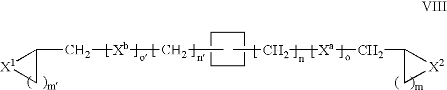

The box may represent one or more structural linkages including aromatic rings(s) or ring system(s), with or without interruption or substitution by one or more heteroatoms, examples of which are given below.

X¹, X² and X^{a} and X^{b} may be the same or different and represent the heteroatoms, oxygen and sulfur. The letter designations, m and m, represent integers within the range of 1 to 3, n and n represent integers within the range of 0 to 8, and o and o represent integers within the range of 1 to 3. The box of the core structure of aromatic rings within the curable resin of structure VIII may be individual aromatic rings, or aromatic ring systems having multiple aromatic units joined in fused ring systems, joined in bi-aryl (such as, biphenyl) or bis-aryl (such as bisphenol A or bisphenol F, or bisphenol compounds joined by a heteroatom) systems, joined in cycloaliphatic-aromatic hybrid ring systems, or joined in oligomeric (such as, novolac-type) systems, examples of which include, among others, naphthalene, anthracene, phenanthracene and fluorene.

For instance, the box may represent the structural linkage

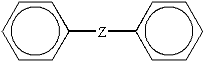

where Z may or may not be present and when present is carbon, or the heteroatom, oxygen or sulfur. Or the box may represent a phenylene group. Either of these representations may bear substitution at one or more locations on the aromatic ring(s) with functional groups ordinarily present on aromatic rings(s), such as alkyl, alkenyl, halo, nitro, carboxyl, amino, hydroxyl, thio, and the like.

For instance, particularly desirable curable resins within structure VIII include MPG, bis[4(2,3-epoxy-propylthio)phenyl]-sulfide (CAS Reg. No. 84697-35-8), available commercially from Sumitomo Seika Chemicals Co., Ltd., Osaka, Japan and XBO, xylene bisoxetane (CAS Reg. No. 142627-97-2), available commercially from UBE Industries, Ltd., Tokyo, Japan.

The reworkable composition may further be a curable resin represented by the following structure:

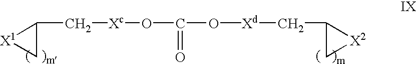

where X¹ and X² are as above; X^{c} and X^{d} may be the same or different, may or may not be present, and when present represent alkyl, alkenyl, aryl and the like; and the letter designations, m and m are as above.

The heteroatom-containing carbocyclic structures pending from the core structure may be three, four or five membered rings with the heteroatom being an oxygen and/or sulfur atom. These ring structures cross-link with one another under appropriate conditions to form reaction products of the compositions.

The carbonate linkage is degradable upon exposure to elevated temperature conditions, with or without the presence of acid. This linkage is capable of degrading to liberate carbon dioxide gas.

A particularly desirable curable resin within structure IX includes CBO, carbonate bisoxetane (CAS Reg. No. 60763-95-3), available commercially from UBE Industries, Ltd., Tokyo, Japan.

The curable resin may also be an epoxy resin where at least a portion of such epoxy resin includes an epoxy resin having at least one alkylene oxide residue position adjacent at least one terminal epoxy group. The epoxy resin may be based on mono- or multi-functional aliphatic epoxies, epoxies with a cycloaliphatic ring structure or system, or epoxies with an aromatic ring structure or system, and combinations thereof.

The epoxy compounds with at least one thermally cleavable anhydride linkage may be chosen from those within the following formula:

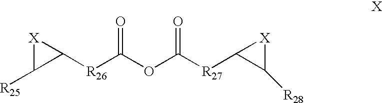

where R₂₅ and R₂₈ are each independently selected from hydrogen, methyl, ethyl, propyl, isopropyl, butyl, isobutyl, t-butyl, C₁₋₄ alkoxy, halogen, cyano and nitro, and R₂₆ and R₂₇ may or may not independently be present, but when present are each independently selected from methylene, ethylene, propylenes, and butylenes, and arylenes, such as phenylenes, benzylenes, phenoxylenes, benzyoxylenes and derivatives thereof, and when R₂₆ and R₂₇ are present, R₂₅ and R₂₆ taken together, and/or R₂₇ and R₂₈ taken together, may form a cyclic or bicyclic structure, such as a carbocyclic e.g., cyclopentyl, cyclohexyl, cycloheptyl or norbornyl) or a heterocyclic, which cyclic structures may be the same or different and may be substituted by straight chain or branched alkyl or alkenyl groups of from 1 to about 6 carbon atoms, which themselves may be substituted by halogen, hydroxyl, or an alkoxy group, such as about C₁₋₄ alkoxy.

The reworkable composition may also include (a) an epoxy resin component, at least a portion of which is a compound having at least one linkage selected from oxiranes, thiiranes, and combinations thereof, substituted on at least three of the substitutable positions on the oxirane and/or thiirane carbons, respectively, with an alkyl, alkenyl or aryl substituent having a carbon content of 1 to about 12 carbon atoms, with or without substitution or interruption by one or more heteroatoms or halogens, as appropriate; and (b) a curing agent component selected from anhydride compounds, amine compounds, amide compounds, imidazole compounds, and combinations thereof.

Particular examples of useful compounds can be found in International Patent Application No. PCT/US00/07452, published Sep. 28, 2000 entitled “Reworkable Thermosetting Resin Compositions,” International Patent Application No. PCT/US00/11878 entitled “Reworkable Thermosetting Resin Compositions,” U.S. Provisional Application No. 60/222,392 filed Aug. 2, 2000 entitled “Reworkable Thermosetting Resin Compositions,” U.S. Provisional Application No. 60/232,813 filed Sep. 15, 2000 entitled “Reworkable Compositions Incorporating Episulfide Resins,” U.S. Provisional Application No. 60/230,098 filed Sep. 5, 2000 entitled “Reworkable Thermosetting Resin Compositions and Compounds Useful Therein,” U.S. Provisional Application No. 60/198,747 filed Apr. 21, 2000 entitled “Reworkable Thermosetting Resin Composition” and U.S. Provisional Application No. 60/193,547 filed Mar. 31, 2000 entitled “Reworkable Thermosetting Resin Composition,” the disclosures of each of which are hereby expressly incorporated herein by reference. It has been discovered through the present invention that such compositions are capable of softening upon exposure to infrared radiation, through conditions as set forth herein.

As indicated, the method of the present invention involves removing the electronic component from the substrate by softening of the cured resin composition. Such softening is achieved by applying infrared radiation directly to the electronic component. In this manner, radiant energy is transferred through the electronic component to the resin composition which is present between and in contact with the electronic component and the substrate. Such radiant energy may transfer directly through the electronic component in the form of light energy, or may transfer indirectly through the electronic component in the form of thermal energy.

For example, the electronic component may be provided in a form which is at least partially transparent to infrared radiation or may be partly transparent to light of a specific wavelength. Electronic components constructed of silicon are particularly useful in this regard, as they are significantly transparent to infrared radiation. When infrared radiation at a specific wavelength is applied directly to the front side of the electronic component, at least a portion of the light will transmit directly through the electronic component to the resin composition. The resin composition therefore aborbs the infrared radiation. With the resin composition being capable of softening under exposure to infrared radiation, such as by having a photolytically cleavable linkage within the polymeric structure thereof, the resin will soften, and will lose its adherence to the substrate.

As a further mechanism, direct application of infrared radiation to the electronic component may cause the electronic component to partly absorb the infrared radiation, thus causing an increase in the temperature of the electronic component. For example, the electronic component may be constructed of a material which partially absorbs infrared radiation, instead of or in addition to being partially transparent to infrared radiation. By applying infrared radiation to the front of the electronic component, it absorbs the infrared radiation, which causes an increase in temperature of the electronic component due to the absorbence of energy from the infrared radiation. This increase in temperature of the electronic component causes radiant thermal energy to transfer through the electronic component. Since the electronic component is contacted by the resin composition on the opposite side thereof, the radiant thermal energy transfers to the resin composition, thus causing an increase in temperature of the resin composition. With the resin composition being capable of softening under exposure to infrared radiation, such as with a photothermally cleavable resin or a resin having a thermally cleavable linkage within the polymeric structure thereof, the resin will soften, and will lose its adherence to the substrate.

In addition, the infrared radiation which is at least partially transmitted directly through the electronic component may also cause the resin composition to increase in temperature. In particular, the infrared radiation transferred directly through the electronic component may be absorbed by the resin composition itself. As such, the resin composition will increase in temperature due to the absorbence of this energy, which increase in temperature may also cause the resin composition to soften.

Absorption of infrared radiation by the resin composition may be enhanced by the presence of additives in the resin composition. For example, infrared absorbing dyes and pigments, such as organic dyes and carbon black, as well as silica can be incorporated into the resin composition to enhance IR absorptivity.

The infrared radiation may be applied to the electronic component at any frequency which is capable of softening the cured resin composition between the electronic component and the substrate. For example, the infrared radiation may be applied at a wavelength of between about 700 and 12,000 nanometers (nm), desirably at about 700-5,000 nm, more desirably at about 800-1,100 nm.

Also, the infrared radiation may be applied to the electronic component using any method known in the art. For example, the infrared radiation may be applied using a focused beam of light, or may be applied using a well collimated beam of light. The beam of light may be applied using an apparatus including a source for producing light, a light guide for delivering the light produced by the source to the electronic component, a sensor for detecting the intensity of the light produced by the source, and a controller for determining the amount of light energy to be delivered to the adhesive composition. Moreover, the light source may be continuous or pulsed, and may be coupled to an accessory, such as an optical-guide device, that can provide energy, spatial, and exposure time control of the radiation emitted. Such devices are known for applying infrared radiation to cure compositions, such as is described in U.S. Pat. No. 5,521,392. An example of a particularly useful device is that sold under the name NOVACURE IR, available from EFOS, Inc. of Mississauga, Ontario, Canada.

In addition to softening of the resin underfill material, removal of the electronic component from the substrate assembly may also involve degrading or breaking of other connections between the electronic component and the substrate. For example, as noted above, the electronic component and the substrate assembly are typically electrically interconnected through electrical contacts, such as solder bumps. Also, adhesive materials in addition to the cured underfill material may provide adherence of the electronic component to the substrate. Removal of the electronic component from the substrate therefore requires breaking these additonal connections formed through a solder joint therebetween. As discussed, the infrared radiation used in the removal process may provide elevated temperatures through thermal energy. As such, in addition to softening and/or degradation of the cured resin composition of the underfill material, the temperature achieved through the use of infrared radiation may also assist in breaking these additional connections. Thus, the application of the infrared radiation is desirably sufficient to cause an increase in temperature which is above the reflow temperature of the solder, so as to result in reflow of the solder during degradation of the underfill composition, as well as any additional adhesive included between the electronic component and the substrate. Such solder reflow temperatures are ordinarily in the vicinity of about 180° C. to 230° C. Alternatively, an additional heat source may be provided to effect solder reflow, apart from the infrared radiation applied for softening of the underfill material.

After softening and/or degradation of the underfill material is achieved through application of infrared radiation, the electronic component can be removed from the substrate. This may be accomplished in any manner, such as through the use of tweezers, mechanical robotic arms, or the like.

While the application of infrared radiation may soften and/or degrade the cured resin composition, such degradation may not be sufficient to entirely remove the resin composition from the substrate. Thus, residue of the resin composition may remain on the substrate after the electronic component is removed therefrom. In order for the substrate to be useful with a new electronic component, it is necessary to remove any of this residual resin composition which may remain on the substrate. Any method may be undertaken to effect removal of such residual resin composition. For example, solvent cleaning, application of electromagnetic radiation, mechanical cleaning, and the like may be useful in this manner. In desirable applications, the residue is removed by mechanical means, such as through the use of a rotating brush. Such a rotating brush should include bristles which rotate at a speed of from about 5,000 to about 30,000 revolutions per minute (rpm), to provide effective mechanical action for cleaning of the residual resin composition. The bristles of such a rotating brush may be constructed of any known material, including synthetic or natural material.

The present invention will be more readily appreciated with reference to the example which follow.

### EXAMPLES

### Example 1

An epoxy-based composition of a Bisphenol F epoxide resin including a cyclophatic epoxide resin with a tertiary ester linkage and a curing agent, available under the name Loctite Underfill 3567 from Loctite Corp., was provided.

The epoxy-based composition was used as an underfill material for FB-250 chips (6×6 m) assembled on FB-250 circuit boards constructed of an epoxy fiberglass composite from Circuit Express, Inc. The epoxy-based underfill material was cured by heating to a temperature of 165° C. for a period of time of 15 minutes.

To effect removal of the chips from the circuit boards, infrared light was directed at the top surface of the chips using an infrared light source available from EFOS, Inc. The infrared light source emitted predominantly in the 800 to 1,100 nm spectral region, and the light output was coupled to a liquid, IR transmitting optical guide of 2-3 feet.

The distance between the tip of the optical guide and the top surface of the chip was fixed at a distance of 3.5 mm, and the power of the infrared light source was varied. During application of the infrared light, the chip was manually removed using a pair of pliers and applying some twisting action. The time necessary to remove the chip from the board was measured, with the results set forth in Table 1:

TABLE 1

| | Distance from tip of | | IR light exposure |
|---|---|---|---|
| | Optical Guide to top | Power at input of IR | time before chip |
| Sample | surface of chip | light wave guide | removal |
| No. | (mm) | (Watts) | (secs) |
| 1 | 3.5 | 10.4 | 10 |
| 2 | 3.5 | 7.2 | 15 |
| 3 | 3.5 | 6.0 | 35 |
| 4 | 3.5 | 3.6 | 60 |

As can be seen from the results of Table 1, exposure time is directly proportional to the power output of the infrared light source. At a higher output of 10.4 watts as in Sample 1, removal of the chip can be achieved in 10 seconds. At an output of 3.6 watts, removal of the same chip can be achieved in 60 seconds.

### Example 2

An epoxy-based composition was prepared in a similar manner as in Example 1, and used as an underfill material for FB-250 chips assembled on circuit boards in a similar manner.

To effect removal of the chip from the circuit board, an infrared light source as in Example 1 was used, with the infrared light being illuminated from the back side of the circuit board, as opposed to directing the light at the top surface as in Example 1. The results are shown in Table 2.

TABLE 2

| | | | IR light |
|---|---|---|---|
| | | | exposure |
| | Distance from tip of | Power at input of IR | time before |
| Sample | Optical Guide to back | light wave guide | chip removal |
| No. | surface of board (mm) | (Watts) | (secs) |
| 5 | 1.0 | 10.4 | 25 |

A comparison of the results of Sample 1 and Sample 5 demonstrates the effectiveness of removal of the chip through the use of infrared radiation, and in particular the effectiveness of illuminating the chip with infrared radiation directed at the top surface of the chip as opposed to the underside or back side of the board. In particular, Sample 5, which involved removal of a chip with infrared radiation directed at the back side of the board, required 25 seconds or exposure before the chip was removed using a pair of pliers and twisting action. Sample 1, on the other hand, involved the same power of infrared radiation illuminated at the top surface of the chip, and at a further distance from the surface than in Sample 5. In Sample 1, however, the chip was removed within 10 seconds using pliers and chip action, resulting in a reduction of chip removal time of 2.5 times.

The invention being thus described, it will be evident to those skilled in the art that the same may be varied in many ways. Such variations are not to be regarded as a departure from the spirit and scope of the invention and all such modifications are intended to be included within the scope of the claims.

What is claimed is:

1. A method of removing an electronic component from a substrate to which the electronic component is electrically interconnected, said electronic component and said substrate being contacted by a cured resin composition which is capable of softening upon exposure to infrared radiation and/or elevated temperature conditions, comprising the steps of:
a) applying infrared radiation directly to the electronic component, such that radiant energy transfers through the electronic component to said resin composition with at least one of the following conditions:
i) said electronic component is at least partially transparent to said infrared radiation causing said infrared radiation to at least partially transmit directly through said electronic component to said resin composition and is absorbed by said resin composition, thereby causing said resin composition to soften;
ii) said electronic component at least partially absorbs. said infrared radiation causing an increase in temperature of said electronic component, which causes an increase in temperature of said resin composition due to said electronic component being contacted by said resin composition, thereby causing said resin composition to soften; and
b) removing the electronic component from the substrate.

2. A method as in claim 1, wherein said electronic component is adhered to said substrate through said resin composition.

3. A method as in claim 1, wherein said infrared radiation at least partially transmitted directly through said electronic component is absorbed by said resin composition and causes said resin composition to increase in temperature, thereby causing said resin composition to soften.

4. A method as in claim 1, wherein said resin composition is a photolytically cleavable resin which includes a photolytically cleavable linkage within the polymeric structure thereof, said photolytically cleavable linkage being capable of degradation upon exposure to infrared radiation.

5. A method as in claim 1, wherein said resin composition is a controllably degradable composition which is capable of decomposing under exposure to temperature conditions in excess of those used to cure the composition.

6. A method as in claim 5, wherein said resin composition is a thermally cleavable resin which includes a thermally cleavable linkage within the polymeric structure thereof, said thermally cleavable linkage being capable of degradation upon exposure to temperature conditions in excess of those used to cure the composition.

7. A method as in claim 6, wherein said thermally cleavable resin comprises the reaction product of a compound having at least one thermally cleavable linkage, a curing agent component for promoting cure of said compound, and optionally, an inorganic filler component.

8. A method as in claim 7, wherein said compound having at least one thermally cleavable linkage is selected from the group consisting of di- or multifunctional epoxides including acyclic acetal groups and full and partial episulfide equivalents thereof; di- or multifunctional epoxides including secondary carbonyl linkages and full and partial episulfide equivalents thereof; di- or multifunctional epoxides including tertiary carbonyl linkages and full and partial episulfide equivalents thereof; di- or multifunctional epoxides including an aromatic moiety within the structure and full and partial episulfide equivalents thereof; and mixtures and combinations thereof.

9. A method as in claim 1, wherein the electronic component is a semiconductor chip or semiconductor device comprising a semiconductor chip electrically interconnected to a carrier substrate.

10. A method as in claim 1, wherein the infrared radiation has a wavelength of from about 700 to about 12,000 nm.

11. A method as in claim 1, wherein the infrared radiation has a wavelength of from about 800 to about 1,100 nm.

12. A method as in claim 1, wherein residue of said resin composition remains on the substrate after said step of removing the electronic component from the substrate.

13. A method as in claim 12, further comprising the step of removing said residue.

14. A method as in claim 13, wherein the residue is removed by mechanical means.

15. A method as in claim 14, wherein said mechanical means comprises a rotating brush, wherein the bristles of said brush rotate at from about 5,000 to about 30,000 rpm.

16. A method as in claim 1, wherein the infrared radiation is applied using a well collimated beam of light.

17. A method as in claim 1, wherein the infrared radiation is applied using a focused beam of light.

18. A method as in claim 17, wherein the focused beam of light is applied using an apparatus comprising a source for producing light; a light guide for delivering the light produced by the source to the electronic component; a sensor for detecting the intensity of the light produced by the source; and a controller for determining the amount of light energy to be delivered to the adhesive composition.

19. A method of softening a cured underfill sealant disposed between an electronic component and a substrate, comprising the step of: applying infrared radiation having a wavelength of from about 700 to about 12,000 nm directly to the electronic component, wherein said infrared radiation causes an increase in temperature of the electronic component, thereby causing an increase in temperature of said underfill material, and wherein said infrared radiation at least partially transmits through said electronic component to said underfill material and is absorbed by said underfill material, thereby causing an increase in temperature of said underfill material said increase in temperature of said underfill material causing said underfill material to soften.

20. A method as in claim 19, wherein said underfill sealant comprises a thermally cleavable resin which includes a thermally cleavable linkage within the polymeric structure thereof, said thermally cleavable linkage being capable of degradation upon exposure to temperature conditions in excess of those used to cure the composition.

21. A method of softening a cured underfill sealant disposed between an electronic component and a substrate, comprising the step of applying infrared radiation having a wavelength between about 700 and 12,000 nm directly to the electronic component, said infrared radiation passing directly through said electronic component and being adsorbed by said underfill material, said underfill material softening upon exposure to said infrared radiation.

22. A method as in claim 21, wherein said underfill sealant comprises a photothermally cleavable resin which includes a photothermally cleavable linkage within the polymeric structure thereof, said photothermally cleavable linkage being capable of degradation upon exposure to infrared radiation.
